(19) United States
(12) Patent Application Publication
(10) Pub. No.: US 2017/0134183 A1
(43) Pub. Date: May 11, 2017

(54) METHOD AND DEVICE FOR COMMUNICATION OF A VOLTAGE REGULATOR OF A MOTOR VEHICLE ALTERNATOR ON AN ON-BOARD NETWORK, AND CORRESPONDING VOLTAGE REGULATOR AND ALTERNATOR

(71) Applicant: VALEO EQUIPEMENTS ELECTRIQUES MOTEUR, Creteil-Cedex (FR)

(72) Inventors: Laurent LABISTE, Saint Maur des Fossés (FR); Pierre CHASSARD, Creteil (FR); Pierre TISSERAND, Limeil Brevannes (FR); Pierre-François RAGAINE, Saints (FR)

(21) Appl. No.: 15/129,879

(22) PCT Filed: Mar. 4, 2015
(86) PCT No.: PCT/FR2015/050526

§ 371 Date: Sep. 28, 2016

(30) Foreign Application Priority Data
Apr. 14, 2014 (FR) 1453289

(51) Int. Cl. H04L 12/40; H02P 9/48

(52) U.S. Cl. CPC H04L 12/40; H02P 9/48; H04L 2012/40273; H04L 2012/40234

(57) ABSTRACT

A communication method and device of a voltage regulator of a motor vehicle alternator on an onboard network, and corresponding voltage regulator and alternator. The communication method according to the invention, for a voltage regulator (36) of a motor vehicle alternator on an onboard network of the vehicle, consists of exchanging information frames on a serial bus (43) according to one or more different proprietary protocols compatible with a standardised protocol. According to the invention, the information frames are encoded or decoded depending on controls and statuses of a standard voltage regulator having predefined characteristics, and the method comprises steps of reading or writing the information frame fields depending on the predefined locations and lengths of same, converting the field values by means of a linear interpolation (39), and addressing the control and status registers (35) of the standard voltage regulator based on predefined parameters.

### TECHNICAL FIELD OF THE INVENTION

The present invention relates to a method and a device for communication of a voltage regulator of a motor vehicle alternator, as well as to a voltage regulator comprising this device for communication, and an alternator comprising this voltage regulator.

### TECHNOLOGICAL BACKGROUND OF THE INVENTION

In the motor vehicle industry, it is well-known to maintain the voltage which is supplied to the on-board electrical network by the alternator of the vehicle at a predetermined set value, independently from the speed of rotation of the motor or the electrical consumption of the equipment, by means of a regulation device which is known as a “regulator”.

Nowadays, motor vehicle parts manufacturers have developed very high-performance alternators by implementing power electronics systems controlled by circuits which use digital techniques, based in particular on the use of microprocessors, microcontrollers or wired logic.

Unlike the previous bimetal regulators which operated around a regulation voltage which was fixed independently from the operating mode of the vehicle, the modern electronic regulation devices take advantage of electronic processing capacities in order to receive variable set values which are transmitted by a control unit of the motor, in order to optimise the torque collected according to the electrical energy production necessary.

The motor control unit can communicate with the regulator of the alternator, and command a particular operating mode of the latter.

The information which is transmitted in return to the control unit of the motor is very often information relating to an excitation current of the alternator.

Depending on the motor vehicle manufacturers, the signals which are representative of this information are different.

A situation of this type has the consequence of making the task of the parts manufacturer more difficult and increasing the costs, since the latter must continually adapt and modify its circuits in order to respond to the needs of different clients.

In order to eliminate these disadvantages, the company VALEO EQUIPEMENTS ELECTRIQUES MOT UR has proposed in application FR2938135 a modular voltage regulator comprising a regulation circuit and a programmable interface.

The common characteristics of the interface are selected by a programming instruction, in order to comply with the specifications of an application from amongst a set of predetermined characteristics.

A similar problem is posed when the interface must be adapted electrically according to applications for different service voltages, for example 12 V or 48 V, and to control excitation currents which are also different, for example for an alternator of a passenger vehicle or for an alternator of a heavy utility vehicle.

Even if the regulation circuit is produced in the form of an ASIC (acronym for “Application Specific Integrated Circuit”) which is standard for all the applications, whereas an interface circuit is produced in the form of another ASIC, changing according to the application, the numerous external interconnections (known as bonding) required between the two circuits make it difficult to implement a solution of this type.

The inventive body has already provided a solution to this problem by designing a modular voltage regulator in which the interface circuit and the regulation circuit constitute respectively a first electronic unit and a second electronic unit which are distinct and connected by a synchronous two-way serial connection.

However, although the electrical connections between the regulator and the control unit of the motor have been simplified and standardised by implementation of a field bus of the LIN type (acronym for “Local Interconnection Network”), the structure of the protocol frames, their content and their interpretation diverge according to the specifications of the vehicle manufacturers.

Since the initial version 1.0 of 1999 and up to version 2.2A of 2010, and ISO17987, the specifications of the LIN network have undergone a plurality of developments which tend to facilitate the integration of a network and improve the real-time characteristics.

All the details of these specifications are well known to persons skilled in the art, and reference will be made hereinafter only to those which are necessary for understanding of the invention. The exchange of information on the LIN network is based on the presence of a master station and one or a plurality of slave stations. The communication is always carried out on the initiative of the master station, which sends a message header comprising a silence followed by a synchronisation byte, and an identification byte, or recogniser.

When a stave station has decoded a predetermined recogniser, it transmits a data frame in response, comprising a plurality of data bytes and a checksum.

The header and the data frame form a message frame.

It should be noted that the message recogniser is representative of the content of the message, but not its destination.

An recogniser IDF[7:0] is formed by an identifier ID[0:5] which is encoded on six bits, and two parity bits P0=ID0+ID1+ID2+ID4 (mod. 2) and P1=ID1+ID3+ID4+ID5 (mod. 2).

There are 64 different identifiers, but only the 60 first (from 00 to 3B in hexadecimal representation correspond to message frames.

The last four identifiers are special identifiers, in particular frames for command, configuration and diagnostics.

For example, the following table establishes the list of the identifiers and recognisers Which are valid according to revision 2.0 of the LIN protocol specifications:

TABLE I

| Identifier | Recogniser | |
|---|---|---|
| ID[0:5] | IDF[7:0] | Type of frame |
| 00 to 3B | P1P0ID[5:0] | Message frame |
| 3C | 3C | Command frame (request by the |
| | | master station) |
| 3D | 7D | Command frame (response by the |
| | | slave station in the frame) |
| 3E | FE | Extended frame defined by the user |
| 3F | BF | Frame of the future extended type |

This table shows that the number of fields, their size, their position and their interpretation can be highly variable, whilst remaining within the standard.

During developments of the standard, the main characteristics of the LIN network have not been fundamentally modified, and its output is still limited to 20 Kbit/s because of constraints of electromagnetic compatibility and clock synchronisation without the use of quartz or a ceramic resonator.

There are numerous versions of LIN according to the manufacturers.

At present, the different regulators for alternators on the market continue to be “made-to-measure” products which systematically require modification of the hardware (new sets of ASIC masks) as soon as there is the slightest variation of field transmitted by the LIN protocol, whether this is the position of these fields, their length, their resolution or their interpretation, or simply in the case of a change of address on the bus.

These regulators all control fixed formatting of the frames with fixed interpretation of the values (resolution, gain, particular points, etc.), and only default values can be parameterised and stored in a memory, for example of the EEPROM type (acronym for “Electrically Erasable Programmable Read Only Memory”).

There is therefore a need for a IAN interface-regulator with a configurable presentation layer which makes it possible to address the different types of encoding of the present frames such as the LIN of the German Automobile Industry Association (VDA) of types A and B, and other LINs used at present in Europe and Japan for example, whilst having sufficient flexibility to comply with new formatting (for example the one which is used by an American manufacturer based on VDA, but with additional fields).

### GENERAL DESCRIPTION OF THE INVENTION

The present invention consequently aims to fulfil this need.

According to a first aspect, the invention relates to a method for communication of a voltage regulator of a motor vehicle alternator on an on-board network of the vehicle, of the type consisting of exchanging information frames on a serial bus according to one or a plurality of different proprietary protocols which are compatible with a standardised protocol.

According to the invention, the information frames are encoded or decoded according to commands and states of a standard voltage regulator with predetermined characteristics, and the method comprises the steps of:
reading or writing fields of the information frames according to their locations and their predetermined lengths;
conversion of the values of the fields by linear interpolation; and
addressing the command and state registers of the standard voltage regulator according to predetermined parameters.

According to a particular embodiment, the standardised protocol is the Local Interconnection Network (LIN) protocol.

According to a particular characteristic, the aforementioned interpolation is carried out by a variable number of segments which are each defined by a predetermined limit value, a gain and an offset.

According to another aspect, the invention relates to a device for communication of a voltage regulator of a motor vehicle alternator on an on-board network which can implement the method for communication as briefly described above, wherein information frames are exchanged on a serial bus according to one era plurality of different proprietary protocols which are compatible with a standardised protocol. According to the invention, the device for communication comprises:
means for encoding or decoding the information frames according to commands and states of a standard voltage regulator with predetermined characteristics;
means for reading or writing fields of the information frames according to their locations and their predetermined lengths;
means for conversion of the values of the fields by linear interpolation; and means for addressing the command and state registers of the standard voltage regulator according to predetermined parameters.

The invention also relates to a recording support which can be read by a computer, and to a computer programme product, as well as to a voltage regulator comprising the device for communication briefly described above, and an alternator comprising the aforementioned regulator.

These few essential specifications will have made apparent to persons skilled in the art the advantages provided by the method and the device for communication of a voltage, regulator according to the invention, as well as by the corresponding voltage regulator and alternator, in comparison with the prior art.

The detailed specifications of the invention are given in the description which follows in association with the appended drawings. It should be noted that these drawings serve the purpose simply of illustrating the text of the description, and do not constitute in any way a limitation of the scope of the invention.

### BRIEF DESCRIPTION OF THE DRAWINGS

FIG. 1 is a synoptic diagram of a voltage regulator of a motor vehicle alternator known in the prior art.

FIG. 2 is an example of data frames exchanged on a LIN network by a voltage regulator known in the prior art.

FIGS. 3a and 3b are other examples of data frames transmitted to two different voltage regulators known in the prior art, the interpretation of which is shown in FIG. 3c.

FIG. 4a is an additional example of an information frame transmitted, the interpretation of which is shown in FIG. 4b.

FIGS. 5 and 6 illustrate the method and device for communication of a voltage regulator according to the invention, respectively in reception and in emission.

FIG. 7 is a process diagram of the device for communication of a voltage regulator according to the invention.

FIG. 8a is yet another example of an information frame, and FIG. 8b shows a result of decoding of this frame by the device for communication according to the invention.

FIG. 9 illustrates in detail the decoding of the information frame shown in FIG. 8a.

### DESCRIPTION OF PREFERRED EMBODIMENTS OF THE INVENTION

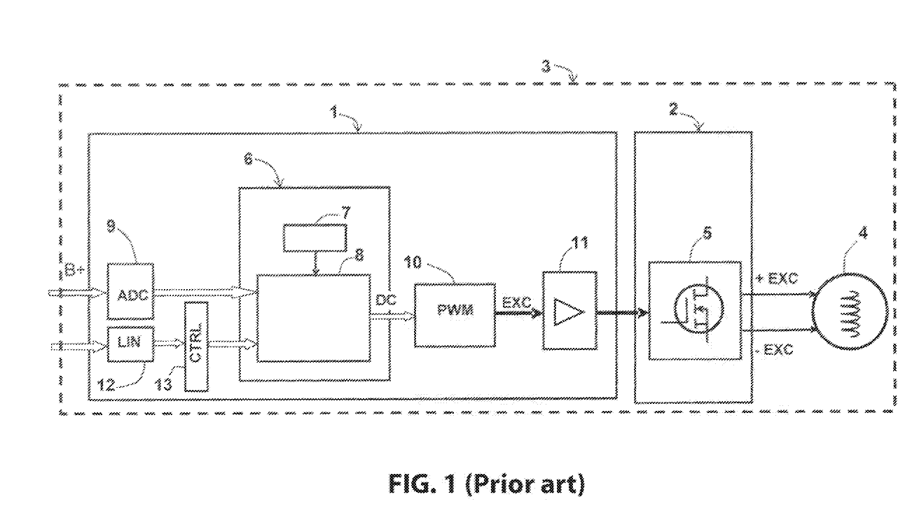

A diagram of a voltage regulator 1, 2 of the type concerned by the invention is represented in FIG. 1.

This is a voltage regulator 1, 2 of a battery B+ which is integrated in an alternator 3 with excitation 4 for an application in a motor vehicle.

As shown by this synoptic diagram, the voltage regulator substantially comprises two parts 1, 2, i.e. a control circuit 1 which is constituted by an ASIC, and power electronics 2 comprising transistors 5 of the MOSFET type (field effect transistor with an isolated gate) for control of the excitation current +EXC, −EXC applied to the excitation winding 4.

The control ASIC 1 comprises in particular:
a control unit 6 and a memory 7 comprising sequences of instructions 8 which in particular carry out the regulation functions;
an analogue-digital converter 9, which is designed to acquire samples of the direct voltage B+ produced by the machine;
a generator 10 for pulses with modulated duration EXC;
an amplifier 11 for these pulses EXC controlling the transistors 5 of the power electronics 2.

The set value of the regulation loop is set via a circuit 12 for interface with the LIN (Local Interconnection Network) standard on-board network and a control register 13.

The LIN protocol makes it possible to transfer a large amount of data but, as stated in the preamble, depending on the manufacturers, it has led to divergence relating to the frequency (baud rate) of use, the number of fields transmitted, and their size, position and interpretation.

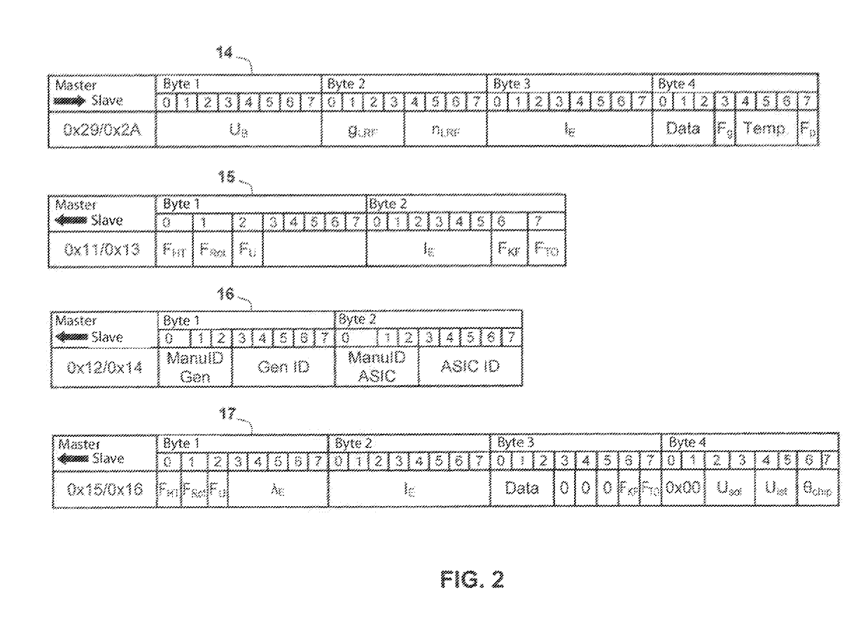

FIG. 2 shows an example of an information frame 14 generated by a master device, destined for the control circuit 1 of the voltage regulator 1, 2.

This figure also shows data frames 15, 16, 17 which are generated in response by the control circuit 1.

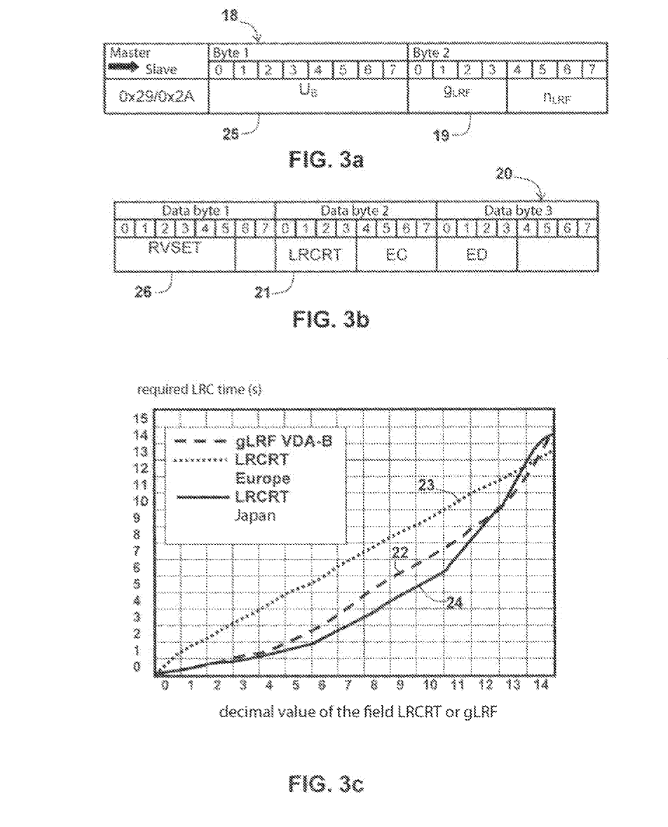

FIG. 3a shows another information frame 18 containing a data field 19 which is specific to the progressive load control (parameter gLRF indicating the response time to a variation of the load on the on-board electrical network within the context of the LRC function of the voltage regulator; LRC is the acronym for “Load Response Control”) for a certain model of alternator 3.

FIG. 3b shows another information frame 20 containing a data field 21 transmitting another parameter LRCRT with a purpose which is identical to the preceding data field, for another model of alternator 3.

FIG. 3c shows that the decimal values of these fields have a different significance in terms of the time of the LRC required.

The decoding of the field gLRF (curve in a broken line 22) according to the variant VDA-B of the protocol leads to times in seconds which are systematically shorter than those derived from the decoding of the field LRCRT (curve in a dotted line 23) used in Europe.

The curve in a solid line 24 shows that the decoding of a field of this type also leads to different times in the case of a manufacturer which in this case is Japanese.

A field corresponding to a single function can also be encoded on a different number of bits, according to the variants of the protocol.

FIG. 3a shows a field 25 corresponding to a set voltage Ub encoded on 8 bits.

The corresponding field 26 RVSET in FIG. 3b is encoded on 6 bits.

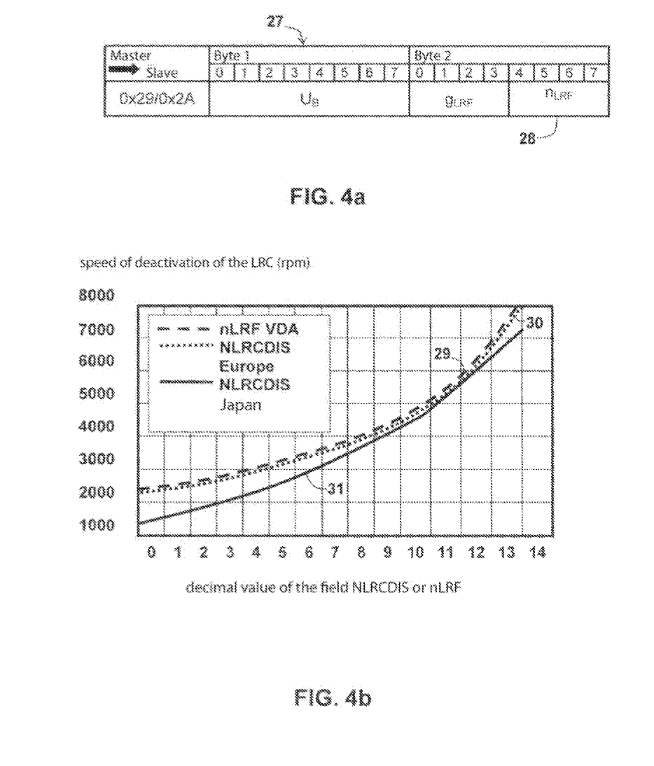

FIG. 4a shows an additional information frame containing a field 28 which transmits an additional parameter nLRF indicating a speed of inactivation of the LRC.

FIG. 4b shows that the decoded speed values are identical according to the VDA protocol (curve in a broken line 29) and in Europe (curve in a dotted line 30).

In Japan, the decoded values are different from the preceding ones (curve in a solid line 31).

There is therefore a multitude of versions of LIN, since each manufacturer changes the allocation of the bit fields, their length, and the interpretation of these fields.

The objective of this invention is therefore to provide a LIN-regulator 12 interface with a configurable presentation layer 32, which makes it possible to address the different types of encoding of the present frames such as the LIN VDA type A, VDA type B, Europe, Japan, etc., whilst having sufficient flexibility to respond to new formatting (for example that of the American manufacturer based on VDA, but with additional fields).

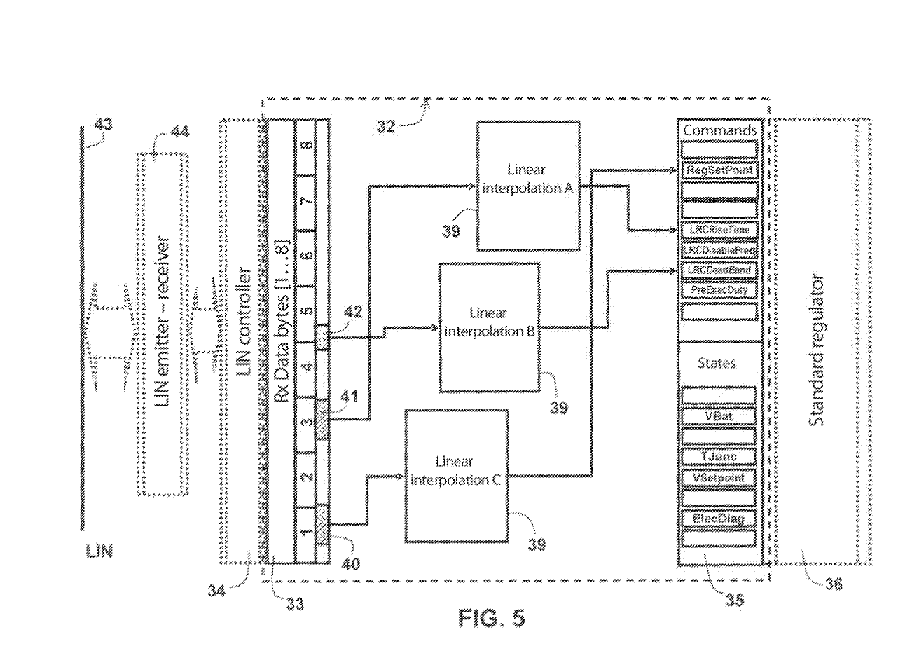

The principle is to interpose between input/output registers 33 of a LIN bus controller 34 of the voltage regulator 1, 2 and a control register 35 of a standard (or generic) regulator 36, two-way routing means 37, 38, for example a multiplexer, and two-way means for correction of formatting, for example an interpolator 39, as shown by FIGS. 5, 6 and 7.

FIG. 5 shows schematically the decoding of three different fields 40, 41, 42, corresponding respectively to three different commands RegSetPoint, LRCRiseTime and LRCDeadBand of the standard voltage regulator 36.

The commands which are transmitted by a master device on the LIN network 43 are received in a manner which in itself is known by an emitter-receiver with a physical layer 44 of the LIN interface 12, and are loaded in the input/output registers 33 of the LIN bus controller 34.

For identical commands of the standard regulator, the three corresponding fields 40, 41, 42 can contain different values according to the variants used of the LIN protocol.

The interpolators 39 make it possible to convert these different values into standard commands loaded in the control register 35 of the standard voltage regulator 36.

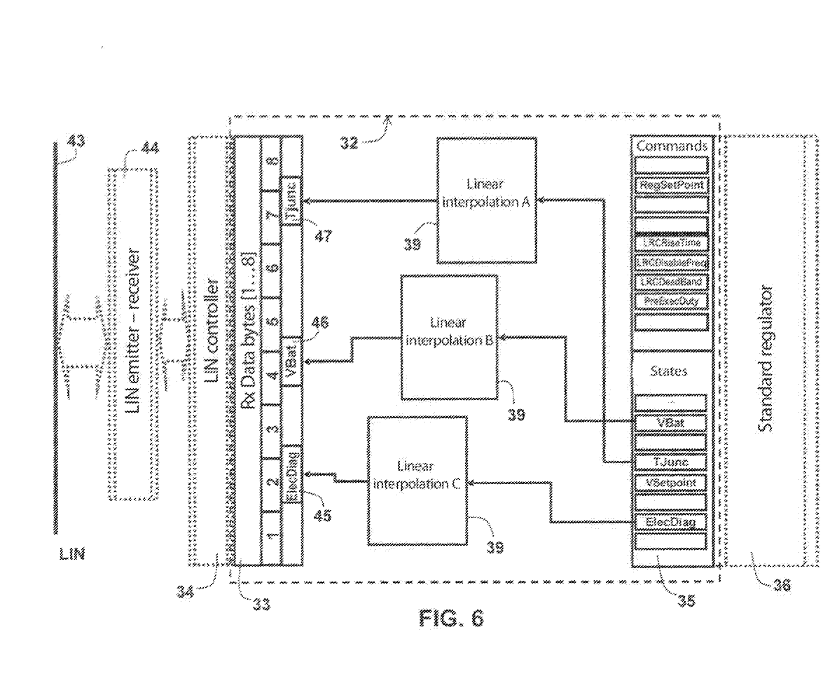

Similarly, FIG. 6 shows schematically the encoding of three other different fields 45, 46, 47, corresponding respectively to three different states ElecDiag, VBat and Tjune of the standard voltage regulator 36 generated by the standard voltage regulator 36 and destined for the master device via the LIN bus 43.

According to the variants of the protocol used, the same variables of state must be translated by different values loaded into the input/output registers 33 of the bus controller 34, before being transmitted. The interpolators 39 ensure this adaptation.

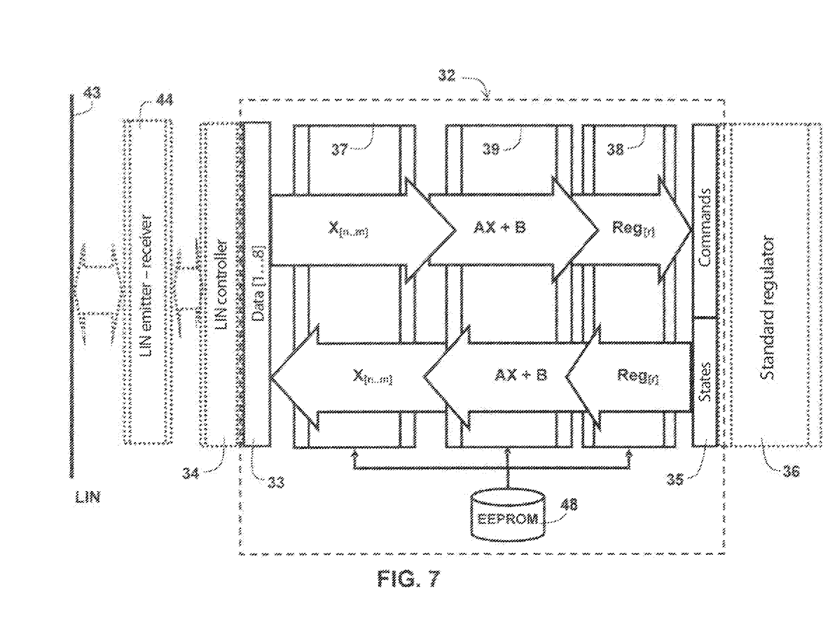

As shown clearly in FIG. 7, the two-way routing means 37, 38 which make it possible to make any field of a data frame 14, 15, 16, 17, 18, 20, 27 correspond to any field of the control register 35, are constituted by:
a configurable binary field addresser 37, which makes it possible to extract or write a contiguous field 19, 21, 25, 26, 28 within the LIN frame, according to its location and its length;
a configurable register addresser 38, which makes it possible to address any field of the control (command/state) register 35 of the standard voltage regulator 36.

The programming of these elements 37, 38 of these routing means is stored in a data storage means, for example a read-only memory 48 of the EEPROM type with a small capacity (for example approximately 1 Kbit).

The interpolators 39 are configurable linear interpolators, the parameters of which are also stored in a read-only memory 48.

In fact, the interpolation is carried out by a variable number of segments n defined by a limit value X_{L}, a gain Aₙ and an offset Bₙ (for Xₙ<X≦Xₙ₊₁ then Y=AₙX+Bₙ).

With these various parameters Aₙ and Bₙ per segment n stored in the memory, it is then possible to carry out almost any type of conversion, and therefore to support most of the current LIN protocols.

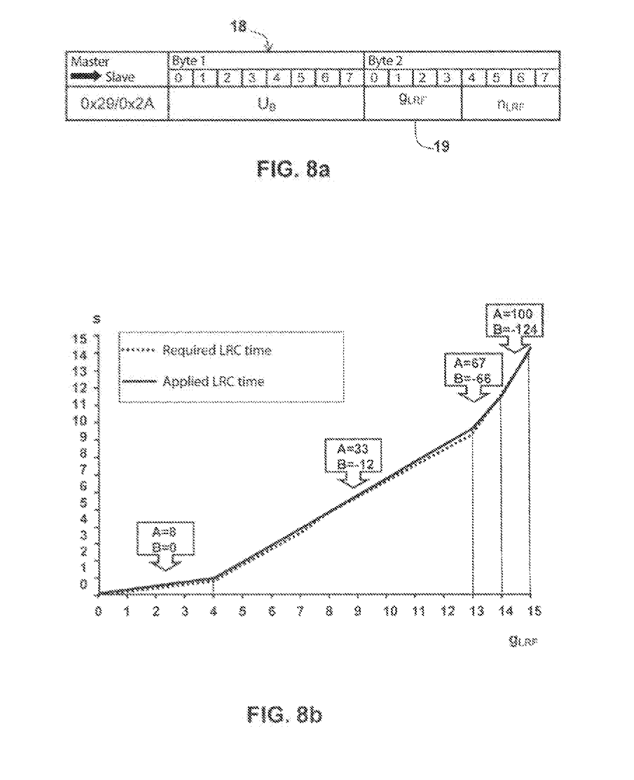

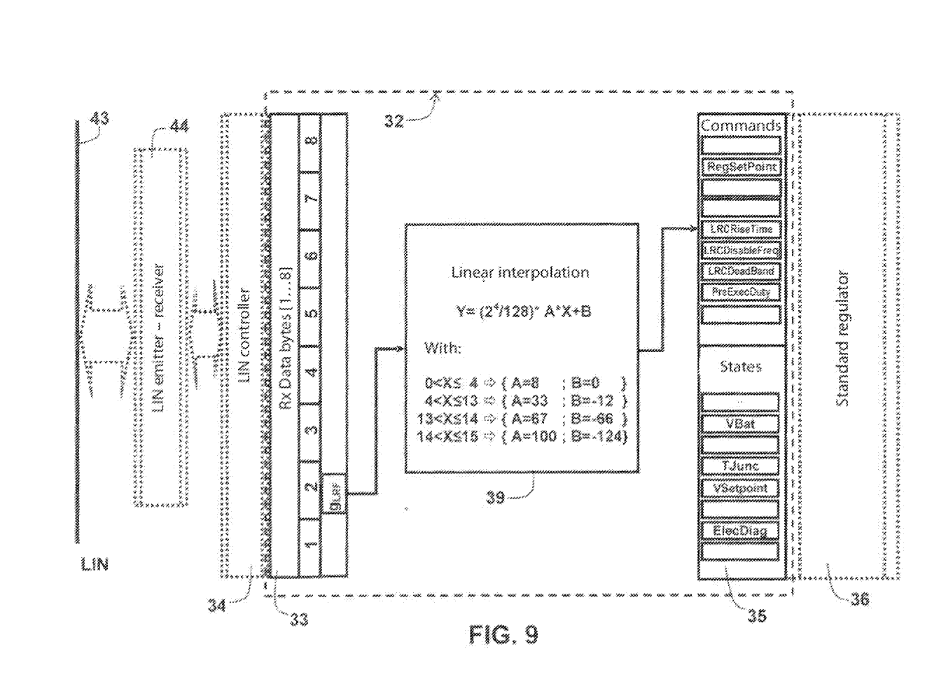

FIGS. 8 and 9 illustrate the conversion of the field g_{LRF} in a VDA frame of type B.

This field 19 corresponds to the command LRCRiseTime.

The standard voltage regulator 36 associates with this command an LRC with a duration which is proportional to the value of the control register LRCRiseTime, which is encoded on 6 bits, and generates an LRC of 0 to 15 seconds.

As shown in FIG. 8a, the field 19 extracted from the LIN frame 18 is for its part encoded on 4 bits.

It should be noted that the calculation Y=A*X+B is carried out with a fixed point expressed on 8 bits, and, in order to make it possible to generate different types of gain, it is effectively carried out by the following operation Y=(2⁴/128)*A*X+B.

FIG. 8b shows the four segments necessary in order to carry out the linearisation.

FIG. 9 shows explicitly the calculations which are carried out on each segment.

These calculations are derived from implementation of one or more programmes, the sequences of instructions of which, stored by a data storage means, are executed by a microprocessor, a microcontroller or a wired logic.

It will be appreciated that the invention is not limited simply to the above-described preferred embodiments.

In particular, the interpolation method described is non-limiting.

The structures of the information frames or of the data frames 4, 15, 16, 17, 18, 20, 27 described are also indicated only by way of example.

Other embodiments would not depart from the context of the present invention, provided that they are derived from the following claims.

1. Method for communication of a voltage regulator (1, 2) of a motor vehicle alternator (3) on an on-board network (43) of said vehicle, of the type consisting of exchanging information frames (14, 15, 16, 17, 18, 20, 27) on a serial bus (43) according to one or a plurality of different proprietary protocols which are compatible with a standardised protocol, wherein said information frames (14, 15, 16, 17, 18, 20, 27) are encoded or decoded according to commands and states of a standard voltage regulator (36) with predetermined characteristics, and in that it comprises the steps of:
reading or writing fields (19, 21, 25, 26, 28) of said information frames (14, 16, 17, 18, 20, 27) according to their locations and their predetermined lengths;
conversion of the values of said fields (19, 21, 25, 26, 28) by linear interpolation; and
addressing the command and state registers (35) of said standard voltage, regulator (36) according to predetermined parameters.

2. Method for communication of a voltage regulator (1, 2) of a motor vehicle alternator (3) on an on-board network (43) according to claim 1, wherein said standardised protocol is the Local Interconnection Network (LIN) protocol.

3. Method for communication of a voltage regulator (1, 2) of a motor vehicle alternator (3) on an on-board network (43) according to claim 1, wherein said interpolation (39) is carried out by a variable number of segments which are each defined by a predetermined limit value, a gain and an offset.

4. Device (32, 34, 44) for communication of a voltage regulator (1, 2) of a motor vehicle alternator (3) on an on-board network (43) which can implement the method for communication according to claim 1, wherein information frames (14, 15, 16, 7, 18, 20, 27) are exchanged on a serial bus (43) according to one or a plurality of different proprietary protocols which are compatible with a standardised protocol, comprising:
means for encoding or decoding he said information frames (14, 15, 16, 17, 18, 20, 27) according to commands and states of a standard voltage regulator (36) with predetermined characteristics;
means for reading or writing fields (19, 21, 25, 26, 28) of said information frames (14, 15, 16, 17, 18, 20, 27) according to their locations and their predetermined lengths;
means for conversion of the values of said fields (19, 21, 25, 26, 28) by linear interpolation; and
means for addressing command and state registers (35) of said standard voltage regulator (36) according to predetermined parameters.

5. Recording support which can be read by a computer, on which there is recorded a computer programme comprising programme encoding instructions for execution of the steps of the method according to claim 1.

6. Computer programme product, comprising programme encoding instructions recorded on a support which can be read by a computer, in order to implement the steps of the method according to claim 1 when said programme is running on a computer.

7. Voltage regulator (1, 2) of a motor vehicle alternator (3), comprising a device (32, 34, 44) for communication according to claim 4, and or a recording support, and/or a computer programme product according to claim 6.

8. Motor vehicle alternator (3), comprising a voltage regulator (1, 2) according to claim 7.

9. Method for communication of a voltage regulator (1, 2) of a motor vehicle alternator (3) on an on-board network (43) according to claim 2, wherein said interpolation (39) is carried out by a variable number of segments which are each defined by a predetermined limit value, a gain and an offset.

10. Recording support which can he read by a computer, on which there is recorded a computer programme comprising programme encoding instructions for execution of the steps of the method according to claim 2.

11. Recording support which can be read by a computer, on which there is recorded a computer programme comprising programme encoding instructions for execution of the steps of the method according to claim 3.

12. Computer programme product, comprising programme encoding instructions recorded on a support which can be read by a computer, in order to implement the steps of the method according to claim 2 when said programme is running On a computer.

13. Computer programme product, comprising programme encoding instructions recorded on a support which can be read by a computer, in order to implement the steps of the method according to claim 3 when said programme is running on a computer.

14. Voltage regulator (1, 2) of a motor vehicle alternator (3), comprising a device (32, 34, 44) for communication, and/or a recording support according to claim 5, and/or a computer programme product.

15. Voltage regulator (1, 2) of a motor vehicle alternator (3), comprising a device (32, 34, 44) for communication, and/or a recording support, and/or a computer programme product according to claim 6.
